(19) United States
(12) Patent Application Publication
(10) Pub. No.: US 2015/0117655 A1
(43) Pub. Date: Apr. 30, 2015

(54) KENNELLY CIRCLE INTERPOLATION OF IMPEDANCE MEASUREMENTS

(71) Applicant: Sony Corporation, Tokyo (JP)

(72) Inventors: Anders Edgren, Beijing (CN); Grace Zhao, Beijing (CN)

(73) Assignee: Sony Corporation, Tokyo (JP)

(21) Appl. No.: 14/086,310

(22) Filed: Nov. 21, 2013

(30) Foreign Application Priority Data
Oct. 30, 2013 (CN) 201310524978.3

(51) Int. Cl. H04R 29/00

(52) U.S. Cl. CPC H04R 29/001
USPC 381/59

(57) ABSTRACT

Embodiments of the invention are directed to systems, methods and computer program products for interpolating impedance data associated with an electronic device. The present invention enables faster electronic device impedance analysis which in turn will have an impact on memory allocation associated with a computing system that controls the electronic device. An exemplary method comprises receiving complex impedance data; converting the complex impedance data to polar impedance data, wherein the polar impedance data defines a Kennelly circle; normalizing the polar impedance data based on at least one parameter associated with the Kennelly circle; and interpolating the polar impedance data for a selected frequency.

### CLAIM OF PRIORITY

The present application claims priority to Chinese Patent Application No. 201310524978.3 filed Oct. 30, 2013, the entire disclosure of which is hereby incorporated by reference in its entirety.

### BACKGROUND

Measuring the impedance of a speaker driver associated with a speaker assembly has become a topic of interest in recent years. This is because of more attention being cast upon closed loop control of the sound being produced by the speaker assembly.

An open control system constitutes some form of sound pressure level (SPL) frequency response adjustment where the better designs utilize a rudimentary speaker assembly model for administrating this adjustment. The open control system is usually realized in a dedicated Digital Signal Processing (DSP) unit which can take the form of either software or hardware.

Synchronizing a closed loop control system generator along with a feedback signal puts demands on speed versus resolution associated with impedance data acquisition, where the latter is also dependent on the allocated computing memory associated with the speaker assembly. The speed and resolution of impedance data acquisition is also dependent on the frequency content of the generated signal (i.e., stimuli) over the speaker driver.

Noise, sink-pulses, or other broad banded signals are the ideal stimuli for speaker impedance measurement. However, these signals are not the preferred playback choices of the typical user, even though most music and speech has similar crest-factors as pink noise. The common way to analyze impedance is to use floating time averages based on time integration processes. This works well on noise but it is always uncertain that music or speech stimuli will contain the required frequencies to excite the speaker assembly's resonance frequency during the averaging time. The present invention is directed to analyzing impedance data in a fast and efficient manner for music or speech stimuli.

### BRIEF SUMMARY

Embodiments of the invention are directed to systems, methods and computer program products for interpolating impedance data associated with an electronic device. An exemplary method for interpolating complex impedance data associated with an electronic device comprises the steps of: receiving, using a computing device processor, the complex impedance data; converting, using a computing device processor, the complex impedance data to polar impedance data, wherein the polar impedance data defines a Kennelly circle; normalizing, using a computing device processor, the polar impedance data based on at least one parameter associated with the Kennelly circle; and interpolating, using a computing device processor, the polar impedance data for a selected frequency. In some embodiments, the electronic device is a speaker.

In some embodiments, the method further comprises determining a radius parameter and a local parameter associated with the Kennelly circle.

In some embodiments, the method further comprises determining the radius parameter based on resistance associated with suspension loss of the electronic device and direct current (DC) resistance associated with the electronic device.

In some embodiments, the method further comprises determining the local parameter based on the radius parameter.

In some embodiments, the method further comprises determining corner frequency indices associated with the Kennelly circle based on the radius parameter and the local parameter.

In some embodiments, the method further comprises revising the radius parameter and the local parameter based on the determined corner frequency indices.

In some embodiments, the method further comprises centering the normalized impedance data.

In some embodiments, the method further comprises determining a quality value of the electronic device based on the interpolated impedance data.

In some embodiments, the selected frequency comprises a resonance frequency.

In some embodiments, the selected frequency comprises a −3 dB cutoff frequency.

In some embodiments, the method further comprises simulating an impedance curve based on the interpolated impedance data.

In some embodiments, the method further comprises determining a shape associated with the Kennelly circle, comparing the shape to at least one stored shape, and determining whether a match exists between the determined shape and the at least one stored shape.

In some embodiments, the electronic device is part of at least one of a mobile phone, a watch, a music player, a camera, a tablet computing device, a non-mobile computing device, or a mobile computing device.

In some embodiments, a resolution of the electronic device is less than or equal to a predetermined resolution.

In some embodiments, the electronic device is associated with a closed loop control system. In a closed loop system, the output of the electronic device is used as a parameter in controlling the electronic device.

In some embodiments, the electronic device is associated with an open loop control system.

In some embodiments, the interpolated impedance data enables control of audio produced by the electronic device, and wherein the electronic device comprises a speaker.

In some embodiments, the audio comprises music or speech.

In some embodiments, an apparatus is provided for interpolating complex impedance data associated with an electronic device. The apparatus comprises: a memory; a processor; and a module stored in the memory, executable by the processor, and configured to: receive the complex impedance data; convert the complex impedance data to polar impedance data, wherein the polar impedance data defines a Kennelly circle; normalize the polar impedance data based on at least one parameter associated with the Kennelly circle; and interpolate the polar impedance data for a selected frequency.

In some embodiments, a computer program product is provided for interpolating complex impedance data associated with an electronic device. The computer program product comprises a non-transitory computer-readable medium comprising a set of codes for causing a computer to: receive the complex impedance data; convert the complex impedance data to polar impedance data, wherein the polar impedance data defines a Kennelly circle; normalize the polar impedance data based on at least one parameter associated with the Kennelly circle; and interpolate the polar impedance data for a selected frequency.

### BRIEF DESCRIPTION OF THE DRAWINGS

Having thus described embodiments of the invention in general terms, reference will now be made to the accompanying drawings, where:

FIG. 1 presents impedance analysis associated with music stimuli, in accordance with embodiments of the present invention;

FIG. 2 presents the magnitude of the impedance data and its parameters, in accordance with embodiments of the present invention;

FIG. 3 presents a Kennelly circle, in accordance with embodiments of the present invention;

FIG. 4 presents a complex plane that comprises the impedance data of FIG. 1 along with parameters associated with the impedance data (e.g., the parameters presented in FIG. 2), in accordance with embodiments of the present invention;

FIG. 5 presents a flow chart for Kennelly interpolation, in accordance with embodiments of the present invention;

FIG. 6 presents centered impedance data, in accordance with embodiments of the present invention;

FIG. 7 presents simulated impedance curves, in accordance with embodiments of the present invention;

FIG. 8 presents an exemplary process flow for interpolating impedance data associated with a speaker, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for interpolating impedance data associated with an electronic device. The present invention enables faster speaker impedance analysis which in turn has an impact on memory allocation associated with a computing system that controls the electronic device. The present invention also enables impedance-controlled digital signal processing of audio produced by an electronic device. In some embodiments, the electronic device is a speaker. This invention is not limited to any particular electronic device. Although the description provided herein is with respect to a speaker, the description may be applied to any electronic device. Therefore, a speaker, as described herein, may refer to any electronic device, including a device that does not produce audio.

Today, impedance measurements of a speaker are averaged, over a limited averaging period, to collect as much information as possible in the speaker's resonance bandwidth. This works if the stimuli is noise, i.e., random frequencies at random magnitude levels, but it is uncertain that music or speech stimuli will excite the speaker's resonance during the limited averaging period. A longer averaging period will slow down the impedance analysis and if the stimuli is too deterministic, i.e., same frequency content repeating itself, the impedance measurements are unreliable. The present invention is directed to a technical solution for solving these technical problems.

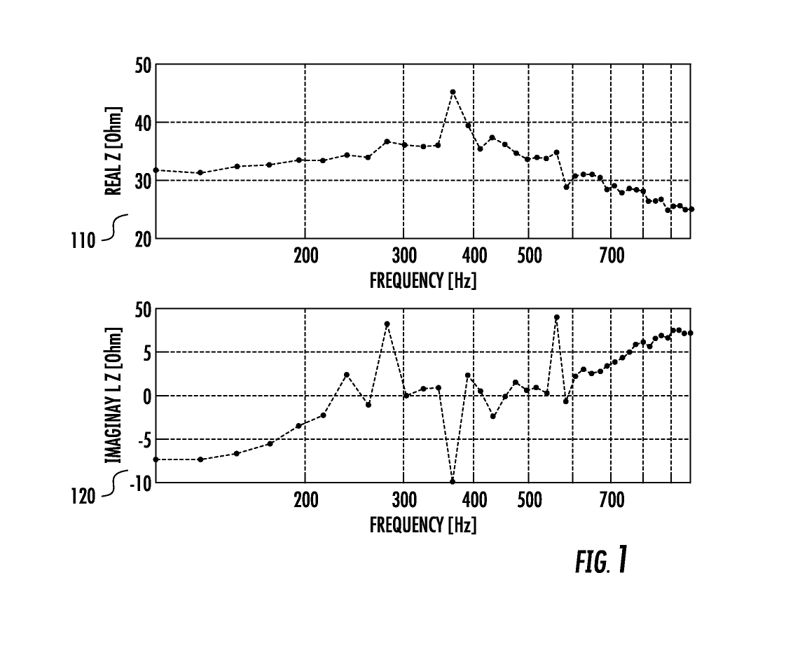

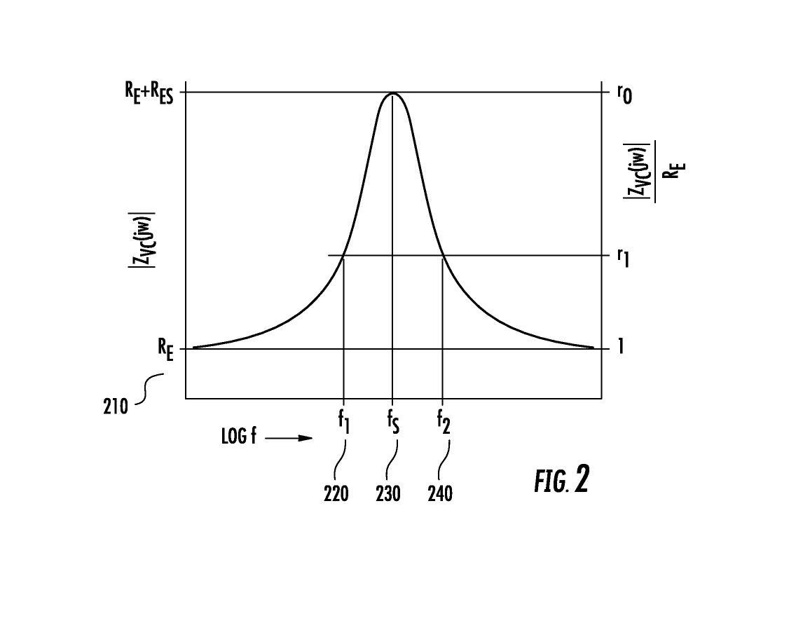

Referring now to FIG. 1, FIG. 1 presents impedance analysis associated with music stimuli. An impedance measurement at a 21.6 Hz frequency resolution is presented in FIG. 1. The impedance data constitutes an average impedance from 10 sample blocks of 46.4 ms, i.e., a total averaging time of 464 ms. Music was used as stimuli and each sample was anti-aliasing filtered and weighted with a Hanning window prior to performing a Fast Fourier transform (FFT). The sample rate was 44.1 kHz which is standard for music stimuli. A sample rate of 8 kHz could be chosen for better frequency resolution. As illustrated in FIG. 1, the impedance data comprises a real component 110 and an imaginary component 120. The sample in FIG. 1 needs additional averaging time to reach the desired parameters presented in FIG. 2.

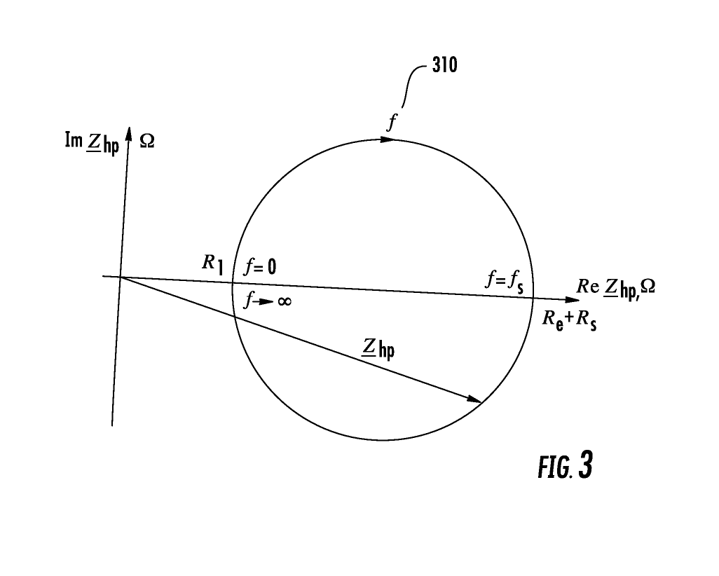

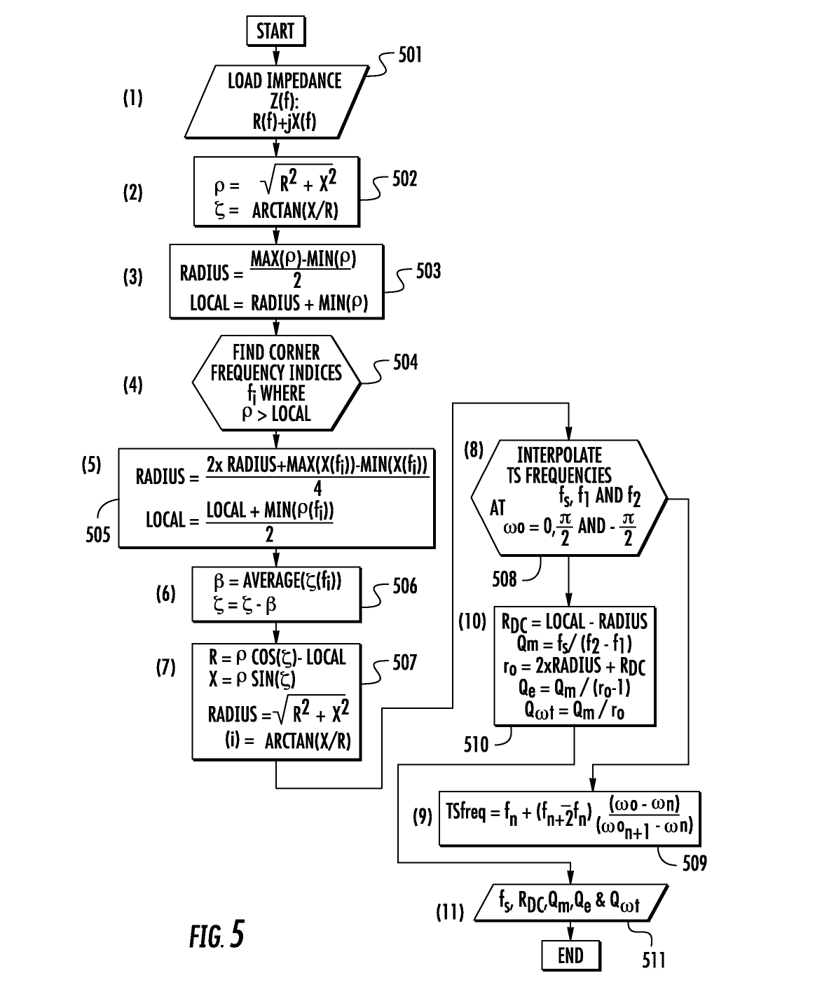

Referring now to FIG. 2, FIG. 2 presents the magnitude of the impedance data and its parameters: DC-resistance R_{E} 210, resonance frequency f_{S} 230 and the −3 dB relative magnitude peak frequencies f₁ 220 and f₂ 240 which will determine the Q value (quality value). FIG. 2 is a reproduction of FIG. 5 from Vol. AU-19, “Direct-Radiator Loudspeaker System Analysis” pp. 269-281. The present invention is directed to interpolating the impedance data by looking for a specific pattern in the data or by determining if the impedance data has a predetermined complex shape. This pattern or shape is known as a Kennelly circle which is depicted in FIG. 3.

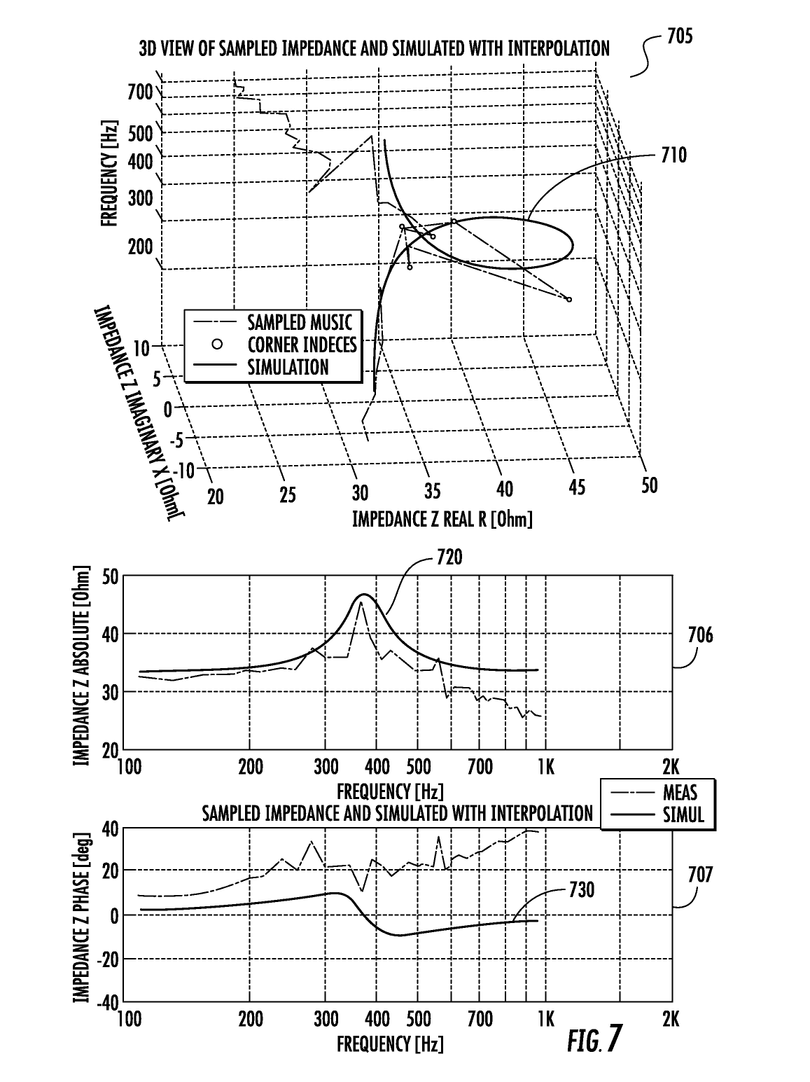

Referring now to FIG. 3, FIG. 3 presents a Kennelly circle. FIG. 3 is a reproduction of FIG. 7.11 from “Acoustics and Electroacoustics” by M. Rossi. The Kennelly circle in FIG. 3 presents the same information as in FIG. 2 but in the complex domain where the frequency axis 310 is represented by the circle formed by the complex impedance values. The present invention is directed to identifying components of the circle where the dynamic range of the impedance measurement is inadequate.

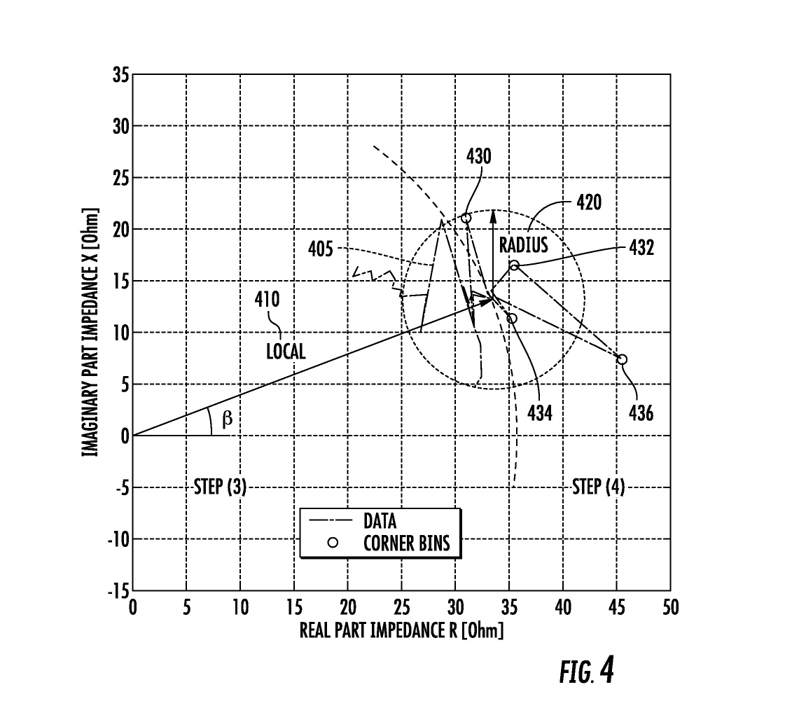

Referring now to FIG. 4, FIG. 4 presents a complex plane that comprises the impedance data 405 of FIG. 1 along with parameters associated with the impedance data. For example, the parameters may be the parameters described with respect to FIG. 2. FIG. 4 also illustrates the radius 410 and local 420 parameters and corner frequency indices or bins 430, 432, 434, and 436 which will be described below with respect to FIG. 5.

Referring now to FIG. 5, FIG. 5 presents a flow chart for Kennelly interpolation. The flow chart taught by the present invention comprises two parts. The first part (steps 501 to 507) is a geometric translation. The second part is an interpolation (steps 508 to 510). The basis of the process flow described herein is that speaker impedance defines a circle in the s-plane, as in FIG. 3, even in low resolution (i.e., a resolution less than or equal to a predetermined resolution).

The complex impedance data is loaded in step 501 and converted to polar form in step 502. The first radius and local assessment on the Kennelly circle is determined in step 503. The radius approximation is basically the same as an ordinary impedance analysis as seen in FIG. 2 where the max (X) is the resistance due to speaker suspension losses R_{E}+R_{ES} and the min (X) is represented by the DC resistance R_{E}. The polar vector local parameter together with its angle β describes the locale of the impedance data which is needed to compensate for combination losses and to center the Kennelly circle by data normalization in step 507. The local parameter is used to identify the impedance frequency bins in step 504 which define the impedance magnitude peak, i.e., the frequency bins in the range f₁ to f₂ in FIG. 2. These frequency bins may also be referred to as corner bins or corner frequency indices.

The corner bins are used in step 505 to improve the radius and local parameters based on an averaging process. The corner bins are also used in step 506 to establish the angle β by averaging all the corner bins angles ζ. The angles ζ of the polar impedance data are also normalized in step 506 which compensates for any rotation caused by combination losses.

The normalization continues in step 507 which results in the centering of the locale of the impedance data. In some embodiments, the centering process can be accomplished using linear vector algebra. In other embodiments, the centering process can be accomplished by converting the impedance data from polar form to complex form, performing operations in complex form, and then converting the data back to polar form.

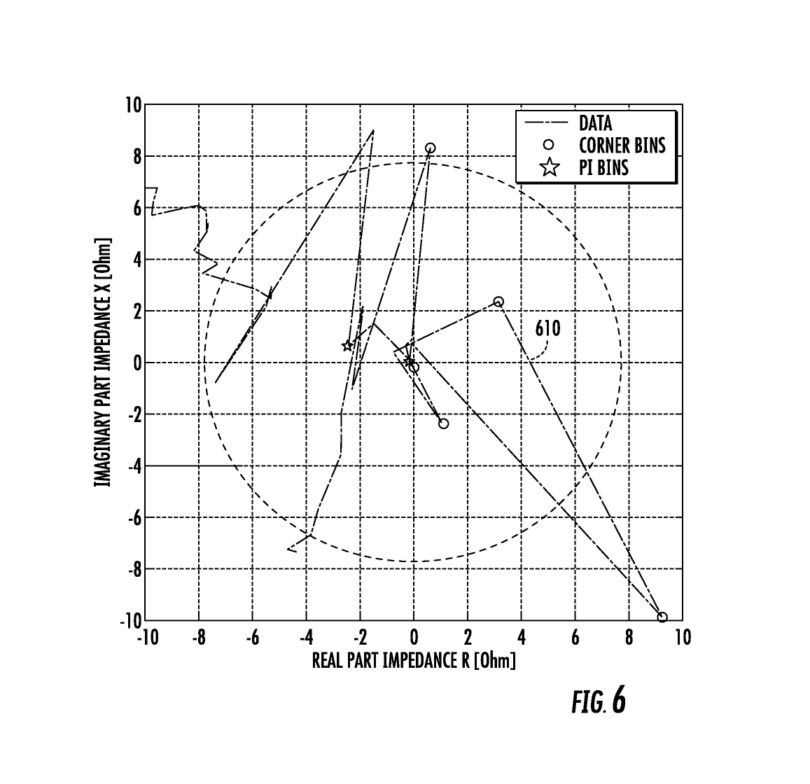

Referring now to FIG. 6, FIG. 6 presents the centered impedance data 610. After the centering normalization of the impedance data has been completed in steps 503 to 507 of FIG. 5, the frequencies of interest (or the impedance at frequencies of interest) can be interpolated, e.g., in a linear fashion as shown in step 509. The speaker's resonance frequency can now be interpolated for ω=0 and the −3 dB cut-off frequencies (or impedance at these frequencies) which determines the Q value at ω=π/2 and ω=−π/2. As used herein, the Q value (Quality value) is a dimensionless parameter that described how under-damped a resonator is.

Referring now to FIG. 7, FIG. 7 presents measured and simulated impedance curves 710, 720, and 730. The last step 510 of FIG. 5 before output of the impedance curves is a standard speaker impedance parameter conversion. With the aid of these parameters, the impedance curves can be simulated as shown in FIG. 7e. The impedance curves are presented in an s-plane in graph 705 and as Bode plots in graphs 706 and 707.

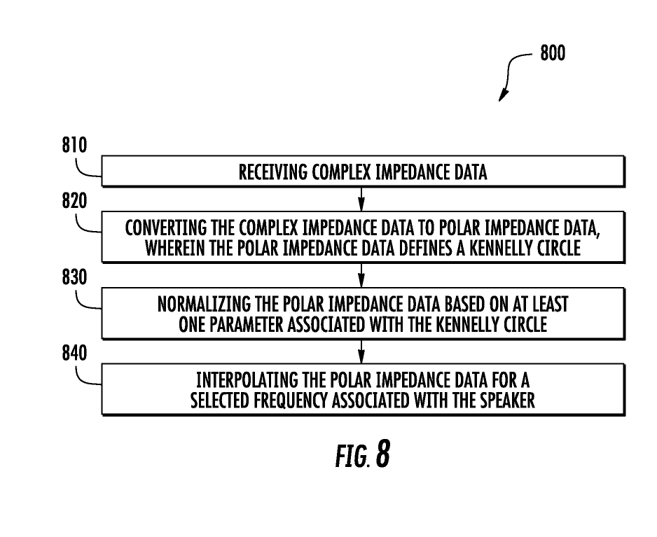

Referring now to FIG. 8, FIG. 8 presents an exemplary process flow associated with the invention. At block 810, the process flow comprises receiving complex impedance data associated with a speaker. At block 820, the process flow comprises converting the complex impedance data to polar impedance data, wherein the polar impedance data defines a Kennelly circle. At block 830, the process flow comprises normalizing the polar impedance data based on at least one parameter associated with the Kennelly circle. At block 840, the process flow comprises interpolating the polar impedance data for a selected frequency associated with the speaker (or associated with audio being produced by the speaker). Although FIG. 8 is described with respect to a speaker, the speaker may represent any electronic device.

The speaker described herein may be part of any portable or non-portable electronic device. For example, the speaker may be part of a portable mobile communication device, a watch, a laptop computer, a speaker system, a music player, or the like. As a further example, the speaker may be a stand-alone device. The various features described with respect to any embodiments described herein are applicable to any of the other embodiments described herein. As used herein, the terms speaker, loud speaker, speaker system, speaker assembly, speaker construction, speaker driver may be used interchangeably. In some embodiments, the present invention is used for interpolating impedance data associated with a speaker when the resolution of the speaker (or the resolution of audio produced by the speaker) is less than or equal to a predetermined resolution.

Although many embodiments of the present invention have just been described above, the present invention may be embodied in many different forms and should not be construed as limited to the embodiments set forth herein; rather, these embodiments are provided so that this disclosure will satisfy applicable legal requirements. For example, there are a plurality of methods for converting complex impedance data to polar impedance data. This application is not limited to any particular method for converting complex impedance data to polar impedance data. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method for interpolating complex impedance data associated with an electronic device, the method comprising:
receiving, using a computing device processor, the complex impedance data;
converting, using a computing device processor, the complex impedance data to polar impedance data, wherein the polar impedance data defines a Kennelly circle;
normalizing, using a computing device processor, the polar impedance data based on at least one parameter associated with the Kennelly circle; and
interpolating, using a computing device processor, the polar impedance data for a selected frequency.

2. The method of claim 1, further comprising determining a radius parameter and a local parameter associated with the Kennelly circle.

3. The method of claim 2, further comprising determining the radius parameter based on resistance associated with suspension loss of the electronic device and direct current (DC) resistance associated with the electronic device.

4. The method of claim 2, further comprising determining the local parameter based on the radius parameter.

5. The method of claim 2, further comprising determining corner frequency indices associated with the Kennelly circle based on the radius parameter and the local parameter.

6. The method of claim 5, further comprising revising the radius parameter and the local parameter based on the determined corner frequency indices.

7. The method of claim 1, further comprising centering the normalized impedance data.

8. The method of claim 1, further comprising determining a quality value of the electronic device based on the interpolated impedance data.

9. The method of claim 1, wherein the selected frequency comprises a resonance frequency.

10. The method of claim 1, wherein the selected frequency comprises a −3 dB cutoff frequency.

11. The method of claim 1, further comprising simulating an impedance curve based on the interpolated impedance data.

12. The method of claim 1, wherein a resolution of the electronic device is less than or equal to a predetermined resolution.

13. The method of claim 1, further comprising determining a shape associated with the Kennelly circle, comparing the shape to at least one stored shape, and determining whether a match exists between the determined shape and the at least one stored shape.

14. The method of claim 1, wherein the electronic device is part of at least one of a speaker, a mobile phone, a watch, a music player, a camera, a tablet computing device, a non-mobile computing device, or a mobile computing device.

15. The method of claim 1, wherein the electronic device is associated with a closed loop control system.

16. The method of claim 1, wherein the electronic device is associated with an open loop control system.

17. The method of claim 1, wherein the interpolated impedance data enables control of audio produced by the electronic device, and wherein the electronic device comprises a speaker.

18. The method of claim 17, wherein the audio comprises music or speech.

19. An apparatus for interpolating complex impedance data associated with an electronic device, the apparatus comprising:
a memory;
a processor; and
a module stored in the memory, executable by the processor, and configured to:
receive the complex impedance data;
convert the complex impedance data to polar impedance data, wherein the polar impedance data defines a Kennelly circle;
normalize the polar impedance data based on at least one parameter associated with the Kennelly circle; and
interpolate the polar impedance data for a selected frequency.

20. A computer program product for interpolating complex impedance data associated with an electronic device, the computer program product comprising:
a non-transitory computer-readable medium comprising a set of codes for causing a computer to:
receive the complex impedance data;
convert the complex impedance data to polar impedance data, wherein the polar impedance data defines a Kennelly circle;
normalize the polar impedance data based on at least one parameter associated with the Kennelly circle; and
interpolate the polar impedance data for a selected frequency.
